(19) United States
(12) Patent Application Publication
(10) Pub. No.: US 2020/0394572 A1
(43) Pub. Date: Dec. 17, 2020

(54) RESERVATION ORDER PROCESSING SYSTEM AND RESERVATION ORDER PROCESSING METHOD

(71) Applicant: TOSHIBA TEC KABUSHIKI KAISHA, Tokyo (JP)

(72) Inventor: Hideo KOBAYASHI, Mishima Shizuoka (JP)

(21) Appl. No.: 16/741,144

(22) Filed: Jan. 13, 2020

(30) Foreign Application Priority Data
Jun. 12, 2019 (JP) 2019-109453
Sep. 20, 2019 (JP) 2019-172157

(51) Int. Cl. G06Q 10/02; G06Q 20/20; G06Q 10/06; G06Q 50/12

(52) U.S. Cl. CPC G06Q 10/02; G06Q 50/12; G06Q 10/063112; G06Q 20/209

(57) ABSTRACT

In one embodiment, a reservation order processing system has an order item acceptance device, an order station, and an output device. The order item acceptance device transmits information of an order including a reception time. The order station obtains a cooking start time based on the reception time, item information of an ordered item, and characteristic information of a person in charge of cooking the relevant item information. Further, the order station transmits cooking instruction information to the output device at the obtained cooking start time.

### CROSS-REFERENCE TO RELATED APPLICATION

This application is based upon and claims the benefit of priority from the prior Japanese Patent Application No. 2019-109453, filed on Jun. 12, 2019, the entire contents of which are incorporated herein by reference.

This application is also based upon and claims the benefit of priority from the prior Japanese Patent Application No. 2019-172157, filed on Sep. 20, 2019, the entire contents of which are incorporated herein by reference.

### FIELD

Embodiments described herein relate generally to a reservation order processing system and a reservation order processing method.

### BACKGROUND

In the food service industry, a restaurant style which not only provides food and drink at the store location, but also provides food items for takeout and/or delivery is increasingly popular. In such a restaurant, an order processing system including a point-of-sale (POS) register and a kitchen printer has been introduced. And when an order of food and drink is accepted, a cooking instruction slip is printed by the kitchen printer.

Upon having accepted an order (a reservation order) for which a specific delivery time or the like has been designated by a customer, a store clerk may write the designated time for the ordered item(s) in a memo column of the cooking instruction slip by hand, and then otherwise processes the reservation order normally. Otherwise, the store clerk may manually print the cooking instruction slip at an estimated appropriate cooking start time to process the reservation order. However, when a store clerk later overlooks the time statement in the memo column, or when an order (a regular order) at the store and a reservation order overlap, efficient processing of the reservation order is not necessarily realized.

### BRIEF DESCRIPTION OF THE DRAWINGS

FIG. 1 is a schematic diagram showing a configuration example of a reservation order processing system according to an embodiment.

FIG. 2 is a block diagram showing a main hardware configuration of the reservation order processing system according to the embodiment.

FIG. 3A is a diagram showing a data table of item information according to the embodiment.

FIG. 3B is a diagram showing a data table of person in charge of cooking characteristic information according to the embodiment.

FIG. 3C is a diagram showing a data table of cooking instruction information according to the embodiment.

FIG. 4 is a flow chart showing a reservation order processing method according to the embodiment.

FIG. 5 is a diagram showing an example of a reservation input screen of the handy terminal according to the embodiment.

FIG. 6A is a diagram showing a cooking instruction slip in the case of a regular order processing to be outputted by the kitchen printer according to the embodiment.

FIG. 6B is a diagram showing a cooking instruction slip in the case of a reservation order processing to be outputted by the kitchen printer according to the embodiment.

FIG. 6C is a diagram showing a cooking instruction slip to be outputted by the kitchen printer according to the embodiment, at the execution start time of the processing for the reservation order.

### DETAILED DESCRIPTION

According to one embodiment, a reservation order processing system has an ordered item acceptance device, an order station, and an output device. The ordered item acceptance device accepts a regular order or a reservation order of an ordered item, and transmits information of the accepted order. The order station receives the information of the order from the ordered item acceptance device, and transmits cooking instruction information based on the information of the order. The output device receives the cooking instruction information from the order station, and displays or prints the received cooking instruction information. Further, the ordered item acceptance device transmits the information of the order including a reception time of the ordered item and item information of the ordered item when the order is the reservation order. Further, the order station has characteristic information of a person in charge pertaining to the item information previously. Further, the order station obtains a cooking start time of the ordered item, based on the reception time and the item information included in the information of the order received from the ordered item acceptance device, and the characteristic information of the person in charge pertaining to the item information. Further, the order station transmits the cooking instruction information to the output device at the obtained cooking start time.

Hereinafter, a reservation order processing system, a reservation order processing method, and a program according to an embodiment will be further described with reference to the drawings. In the respective drawings, the same symbols indicate the same or the similar portions.

[Reservation Order Processing System]

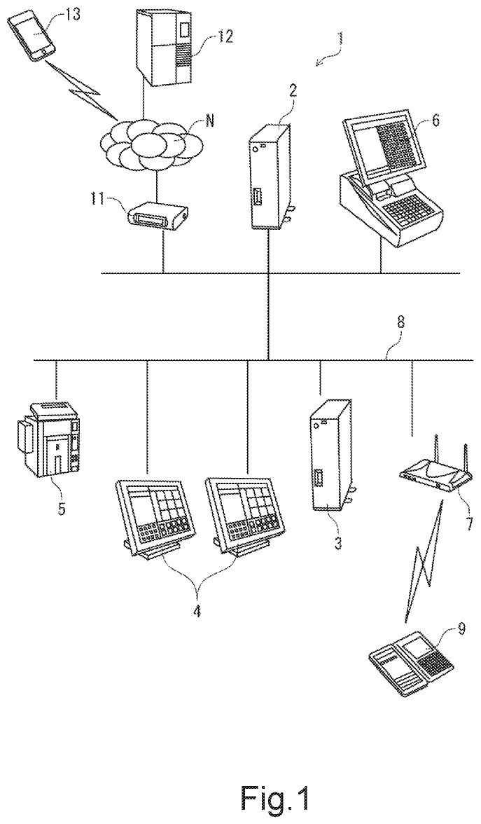

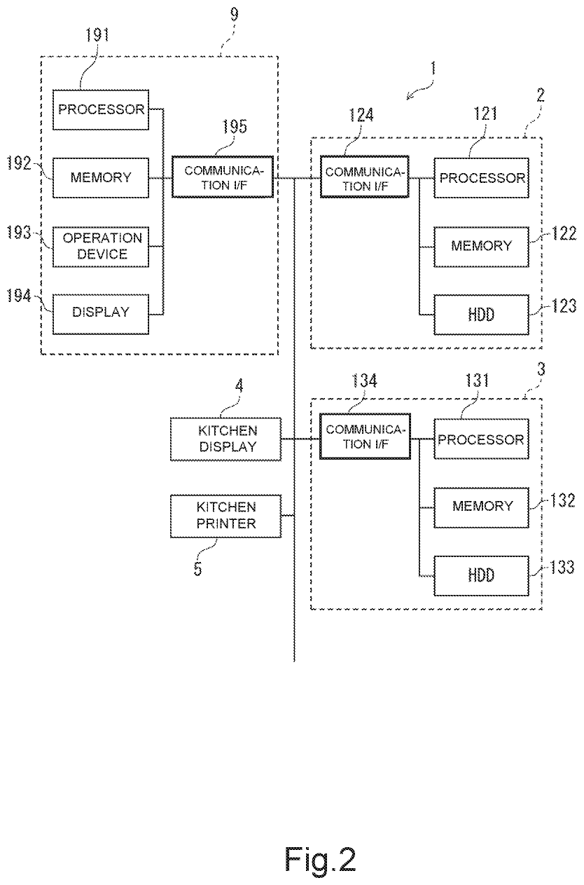

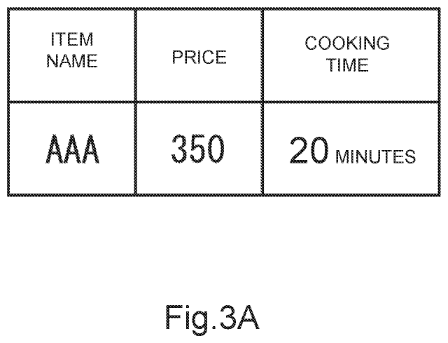

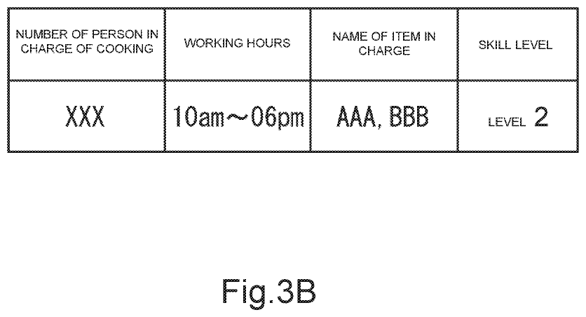

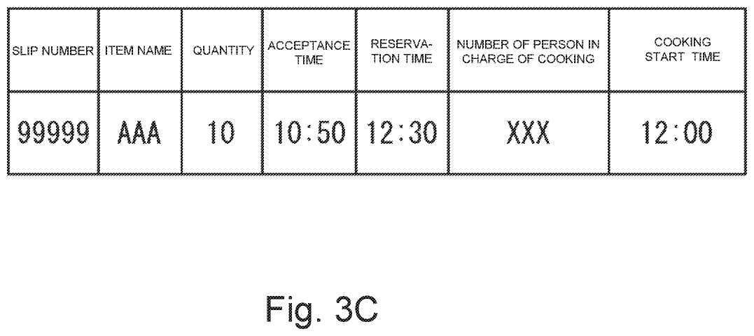

FIG. 1 shows a configuration example of a reservation order processing system 1 of an embodiment. FIG. 2 shows a main hardware configuration of the reservation order processing system 1. FIG. 3A shows a data table of item information. FIG. 3B shows a data table of person in charge of cooking characteristic information. FIG. 3C shows a data table of cooking instruction information.

The reservation order processing system 1 is a part of an order accounting system which is used for order/accounting of food and drink in a restaurant, a box lunch store, and so on for example. The reservation order processing system 1 performs both (two sales channels) of a processing of a regular order in the store, and a processing of a reservation order notified from outside the store. That is, the reservation order processing system 1 doubles as a regular order processing system to perform a processing of a regular order in the store.

The reservation order processing system 1 has an order station 2, a KD sever 3, a kitchen display 4, a kitchen printer 5, a POS register 6, and a wireless communication unit 7, as shown in FIG. 1. These devices 2 to 7 are connected via a communication line 8 such as a wired LAN. In addition, a handy terminal 9 is wirelessly communicatively connected to the wireless communication unit 7.

The order station 2 is a computer server to integrate item information of menus to be provided in the store. The order station 2 has a processor (arithmetic processing unit) 121, a memory 122, a storage device 123, and a communication interface (communication I/F) 124 and so on. The storage device 123 is a hard disk (HDD), for example. Hereinafter, the storage device 123 is called the hard disk 123. The hard disk 123 has a data table in which the various item information as shown in FIG. 3A are integrated. In the item information, an item, a price, a cooking time and so on are included, as shown in FIG. 3A. The cooking time is a standard cooking time of an item (food and drink) of each menu. Information (cooking time information) indicating the cooking time can be set (increased or decreased) arbitrarily by a manager and so on of the store.

In addition, the hard disk 123 has a data table in which the person in charge of cooking characteristic information as shown in FIG. 3B are integrated. The characteristic information for a person in charge of cooking is information showing various characteristics of each potential person in charge of cooking that is working in the store. Here, the person in charge of cooking is a person such as a cook. The person in charge may also or instead be a person in charge of setout after cooking, for example. In the person in charge of cooking characteristic information, an ID number of a person in charge of cooking, working hours, an item in charge, a skill level and so on are included, as shown in FIG. 3B. The item in charge is a name of food and drink whose cooking the person in charge of cooking takes charge. The skill level is a skill level of the person in charge of cooking, and is shown by three-stage evaluation of level 1 to 3, for example. Specifically, as the skill level becomes higher, so the numerical value of the level becomes larger. The person in charge of cooking characteristic information can be arbitrarily set (added, modified, deleted) by a manager and so on of the store.

The order station 2 integrates order information inputted in the handy terminal 9 and so on. And, the order station 2 is also a computer server to provide the cooking instruction information based on the order information, to the kitchen display 4 and/or the kitchen printer 5. For example, the hard disk 123 has a data table in which the various cooking instruction information as shown in FIG. 3C are integrated. The cooking instruction information is notification information for instructing the item information and so on which a customer has ordered, to a person in charge of cooking of the kitchen. In the cooking instruction information, a slip number, an item, a quantity, an acceptance time, a reservation time, a number of the person in charge of cooking, a cooking start time and so on are included, as shown in FIG. 3C.

The memory 122 of the order station 2 stores various programs. The processor 121 of the order station 2 executes the program stored in the memory 122, to function as an order integration module, a cooking start time calculation module, and an output control module, for example. The processor 121 functions as the order integration module, to integrate the item information (FIG. 3A) of food and drink, and the person in charge of cooking characteristic information (FIG. 3B), and accepts order information of an ordered item such as food and drink in which a reception time of the ordered item by a customer is designated. The processor 121 functions as the cooking start time calculation module, to obtain a cooking start time based on the reception time, the item information and the person in charge of cooking characteristic information. The processor 121 functions as the output control module, to generate the cooking instruction information based on the order information. And the processor 121 transmits the cooking instruction information to the KD (Kitchen Display) server 3 and/or the kitchen printer 5 via the communication interface 124, so as to make the kitchen display 4 display the cooking instruction information, and/or so as to make the printer 5 print a cooking instruction slip including the cooking instruction information at the cooking start time.

The KD server 3 is a computer to control the kitchen display 4. The KD server 3 has a processor (arithmetic processing unit) 131, a memory 132, a hard disk 133, and a communication interface (communication I/F) 134 and so on. The processor 131 of the KD server 3 receives the cooking instruction information from the order station 2 via the communication interface 134. And the processor 131 makes the kitchen display 4 display the cooking instruction information. That is, the kitchen display 4 is a display device to display the cooking instruction information. The kitchen display 4 receives the order information from the KD server 3, and displays the cooking instruction information. For example, the KD server 3 controls the kitchen display 4 to change a display color of the cooking instruction information to be displayed on the kitchen display 4. Further, the KD server 3 controls the kitchen display 4 to change (move) a display area of the cooking instruction information in the kitchen display 4. By this means, the KD server 3 notifies the person in charge of cooking of the kitchen of a cooking waiting state, a cooked state and so on in real time. By this means, information of the cooking state and so on is transmitted to the person in charge of cooking of the kitchen. The KD server 3 and the kitchen display 4 function as the output device, similarly as the kitchen printer 5.

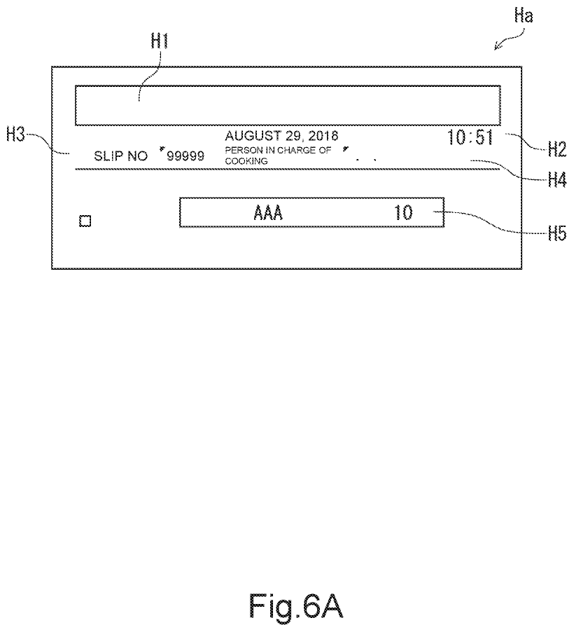

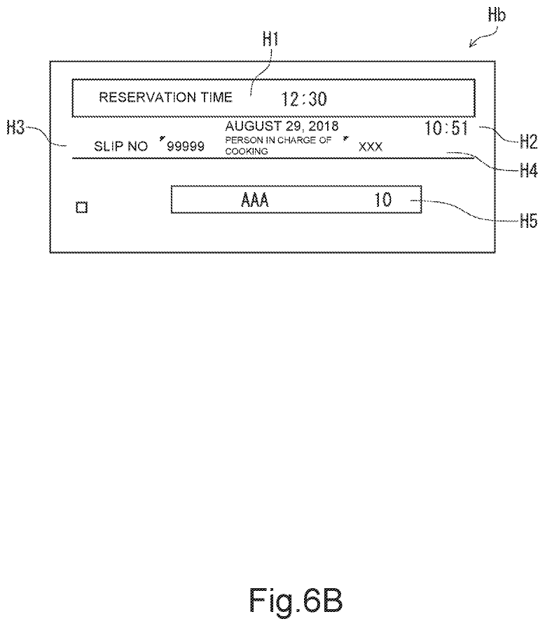

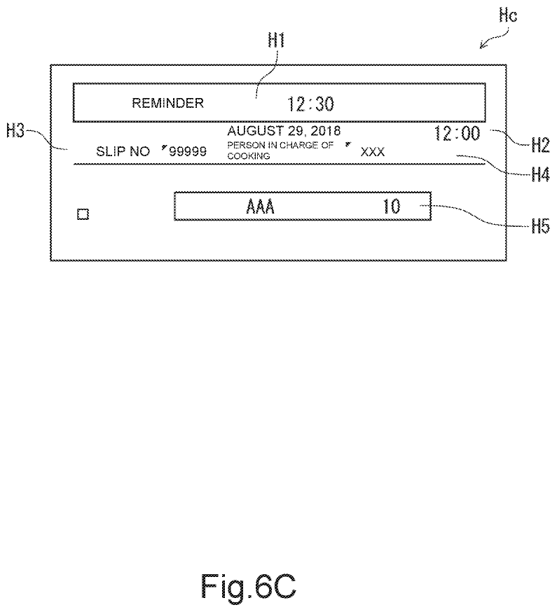

The kitchen printer (output device) 5 is a printing device to issue the cooking instruction slip in which the cooking instruction information for instructing the item information which a customer has ordered to the person in charge of cooking of the kitchen is printed on a paper piece. The kitchen printer 5 receives the cooking instruction information from the KD server 3. And the kitchen printer 5 issues cooking instruction slips Ha, Hb, Hc (refer to FIG. 6A to FIG. 6C) in each of which the cooking instruction information is printed on a paper piece.

The POS register 6 is an accounting device to be installed at a checkout counter. The POS register 6 receives the order information from the KD server 3 to perform an accounting processing. The wireless communication unit 7 is installed on a ceiling of the store, and performs wireless communication with the handy terminal 9.

The handy terminals (order acceptance devices) 9 are a plurality of small size terminal devices each of which a store clerk individually carries. The handy terminal 9 has a processor (arithmetic processing unit) 191, a memory 192, an operation device 193, a display 194, a communication interface (communication I/F) 195 and so on. The handy terminal 9 accepts an input of the order information such as an item name and a quantity which have been ordered by a customer. The handy terminal 9 transmits the inputted information to the order station 2. In addition, the handy terminal 9 sometimes accepts an input of a reservation order. The reservation order is an order in which a reception time of the ordered item by a customer is designated.

The terminal adapter 11 is further connected to the communication line 8. A headquarter management server 12 is connected to the terminal adapter 11 via Internet N. That is, the order station 2 and the headquarter management server 12 can be communicated with each other via the Internet N. Sometimes, the order station 2 accepts an input (transmission) of a reservation order via the headquarter management server 12. That is, the reservation order processing system 1 is able to accept net reservation of food and drink. Specifically, the headquarter management server 12 has a Web site for reservation. The headquarter management server 12 transmits a reservation order which has been inputted in the Web site for reservation to the order station 2.

The respective numbers of the kitchen displays 4, the kitchen printers 5, the wireless communication units 7 and the handy terminals 9 are optional.

[Reservation Order Processing]

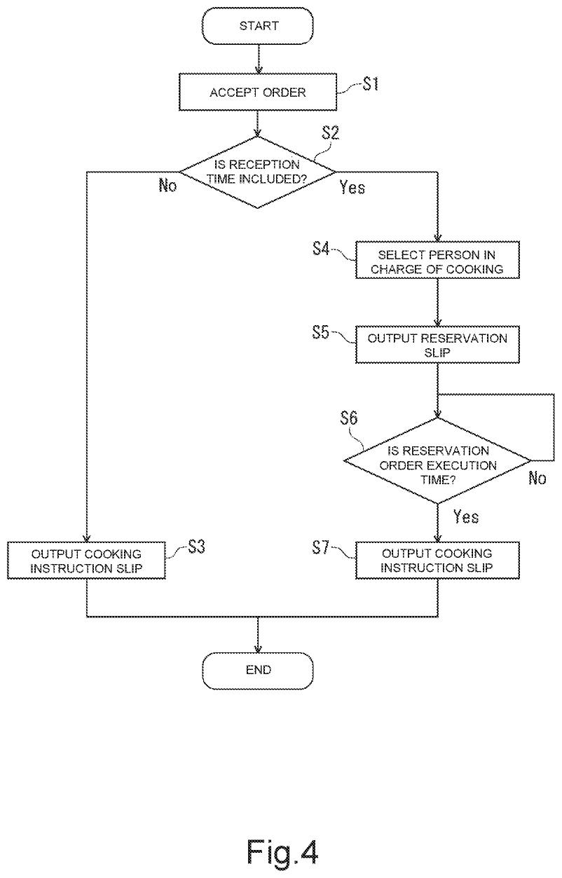

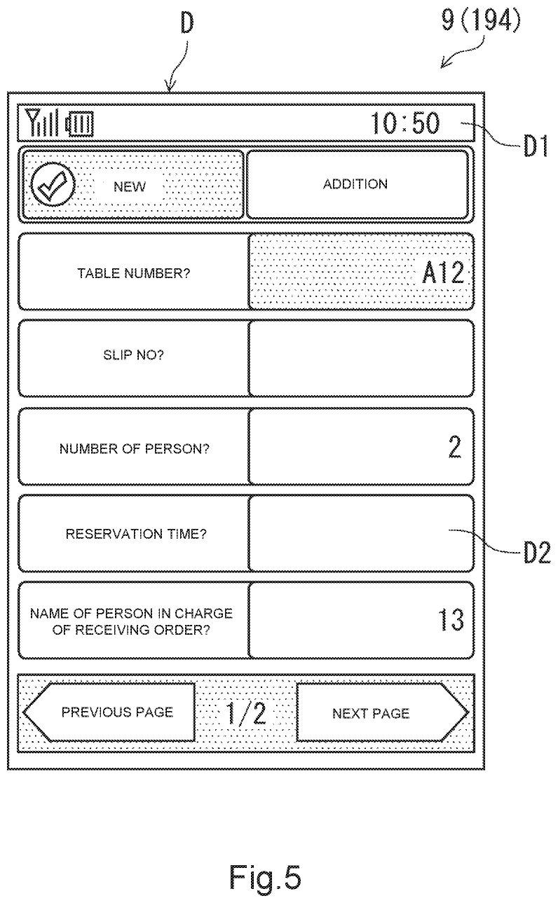

FIG. 4 shows control of a reservation order processing. FIG. 5 shows an example of a reservation input screen of the handy terminal 9. FIG. 6A is a cooking instruction slip to be outputted by the kitchen printer 5 in the case of a regular order processing. FIG. 6B is a cooking instruction slip in the case of the reservation order processing. FIG. 6C is a cooking instruction slip at the time of executing a processing for the reservation order.

[Regular Order Processing]

To begin with, a regular order processing, that is an acceptance processing of an order in the store, will be described. The reservation order processing system 1 accepts an order in the store via the handy terminal 9. That is, in a step S1 of FIG. 4, the processor 121 of the order station 2 receives order information to perform an order acceptance. Specifically, in the store, a store clerk directly catches an order from a customer who has visited the store. The store clerk inputs the content of the caught order into the handy terminal 9. The handy terminal 9 transmits the inputted information (order information) to the order station 2. For example, as shown in FIG. 5, an order screen D including the order information is displayed on the display 194 of the handy terminal 9. In the order screen D, an area D1 in which a current time is to be displayed, and an area D2 in which a reservation time (reception time) is to be inputted are provided. In the area D1, “10:50” is displayed, for example. In the case of the regular order processing, the store clerk does not input a reservation time in the area D2. The handy terminal 9 transmits the order information in which a reservation time has not been inputted (the area D2 is blank) to the order station 2.

When having received the order information, the processor 121 of the order station 2 confirms whether or not a reservation time (reception time) is included in the order information in a step S2. In the case of the regular order processing, the reservation time is not included in the order information, as described above. When the processor 121 confirms that the reservation time is not included in the order information (step S2: No), the processing of the processor 121 proceeds to a step S3. In the step S3, the processor 121 of the order station 2 instructs to output the cooking instruction slip Ha. That is, the processor 121 generates cooking instruction information based on the above-described received order information. And the processor 121 transmits the cooking instruction information to the KD server 3 and/or the kitchen printer 5. The processor 121 transmits the cooking instruction information to the kitchen printer 5, to instruct the kitchen printer 5 to output the cooking instruction slip Ha including the cooking instruction information. In addition, the processor 121 transmits the cooking instruction information to the KD server 3, to instruct the kitchen display 4 to output the cooking instruction information. In addition, in the above-described cooking instruction information, the reservation time (reception time), the number of the person in charge of cooking, the cooking start time are not included.

When having received the cooking instruction information from the order station 2, the kitchen printer 5 prints the cooking instruction information on a paper piece to issue the cooking instruction slip Ha that is a slip in the case of the regular order processing shown in FIG. 6A. In an area H1 of the cooking instruction slip Ha, a reception time of the ordered item by the customer is not stated. In the case of the regular order processing, it is necessary to instantly start cooking, the area H1 is made blank (not stated). In addition, in the cooking instruction slip Ha, an area H2 for displaying the time when the slip has been outputted is provided. In the area H2, “Aug. 29, 2018 10:51” is stated, for example. Further, in the cooking instruction slip Ha, an area H3 for displaying a slip number, an area H4 for displaying a person in charge of cooking, and an area H5 for displaying a name of an ordered item and the number of the ordered items are provided. In the area H3, “99999” is stated, for example. The area H4 is made blank (not stated), or stated as “XXX”, for example. In the area H5, “AAA 10” is stated, for example. The cooking instruction slip Ha is issued from the kitchen printer 5, and thereby a cooking instruction is transmitted to the person in charge of cooking of the kitchen.

That is, the processings from the order acceptance (step S1) from the handy terminal 9 by the order station 2, to the output instruction (step S3) of the cooking instruction information (the cooking instruction slip Ha) in the case of the regular order processing in the kitchen display 4 and the kitchen printer 5 are performed instantly.

Similarly, the processor 131 of the KD server 3 receives the cooking instruction information from the order station 2, and makes the kitchen display 4 display the cooking instruction information. The kitchen display 4 displays the cooking instruction information, based on the instruction of the KD server 3. By this means, the cooking instruction is transmitted to the person in charge of cooking of the kitchen. Accordingly, the person in charge of cooking starts cooking in accordance with the cooking instruction.

[Reservation Order Processing]

Next, the reservation order processing, that is a processing of an order in which a reception time of an ordered item by a customer is designated will be described. Regarding the order (reservation) in which the reception time is designated, sales reservation of a takeout box lunch corresponds to this order, for example. For example, in the step S1 of FIG. 4, the processor 121 of the order station 2 accepts reservation (order), via the handy terminal 9, or the Web site for reservation to be provided by the headquarter management server 12 (an order acceptance process).

Specifically, for example, a customer calls the store from outside the store, and the store clerk directly catches an order from the customer. The store clerk inputs the ordered content into the handy terminal 9. At this time, the store clerk catches the ordered item such as a takeout box lunch along with a reception time, and inputs the reception time into the handy terminal 9.

As shown in FIG. 5, in the display 194 of the handy terminal 9, the order screen D having the area D2 in which the reservation time (reception time) is to be inputted is displayed. In the case of the reservation acceptance, the store clerk inputs the reception time in the area D2. The handy terminal 9 transmits the order information including the reception time inputted in the area D2 to the order station 2. The store clerk inputs “12:30” in the area D2, for example. In this manner, the case of the reservation order processing is different from the case of the regular order processing, in the point that the reception time is designated. And, the information (information of the reservation order) which has been inputted in the handy terminal 9 when the current time is 10:50 (the time which is displayed in the area D1), for example, is transmitted to the order station 2.

In addition, regarding a reservation order via the Web site for reservation, for example, a reservation order may be inputted from an information terminal 13 such as a smartphone which a customer possesses, as shown in FIG. 1. In this case, a reception time of an ordered item by the customer is also inputted from the information terminal 13 such as the smartphone. A column for inputting a reservation time is displayed in a display of the information terminal 13 such as the smartphone (not shown). The information terminal 13 of the customer inputs a reception time in the column of the reservation time, and transmits the order information to the order station 2 when the current time is 10:50, for example. The information (order information) which the customer has inputted into the Web site for reservation is transmitted from the headquarter management server 12 to the order station 2 via the internet N.

When having received the order information, the processor 121 of the order station 2 confirms whether or not the reservation time (reception time) is included in the order information, in the step S2, as described above. In the case of the reservation order processing, the reservation time is included in the order information. When the processor 121 confirms that the reservation time is included in the reservation order (step S2: Yes), the processing of the processor 121 proceeds to a step S4.

Next, in the step S4, the processor 121 of the order station 2 selects a person in charge of cooking who performs cooking of the ordered item. The processor 121 selects the person in charge of cooking who performs cooking of the ordered item, with reference to the person in charge of cooking characteristic information (FIG. 3B) stored in the hard disk 123. Particularly, the processor 121 selects the person in charge of cooking, with reference to the working hours and the item in charge, in the person in charge of cooking characteristic information. The processor 121 selects the person in charge of cooking, and at the same time, obtains an execution start time (cooking start time) of a processing for the reservation order. The execution start time of the processing for the reservation order will be described later.

Next, in a step S5, the processor 121 of the order station 2 instructs to output the cooking instruction slip Hb. The cooking instruction slip Hb is a reservation slip indicating that the reservation order has been received. That is, the processor 121 generates cooking instruction information based on the above-described received order information (a cooking instruction generation process). And, the processor 121 instantly transmits the cooking instruction information to the KD server 3 and the kitchen printer 5 (an output process). The processor 121 transmits the cooking instruction information to the kitchen printer 5, to instruct the kitchen printer 5 to output the cooking instruction slip Hb. In addition, the processor 121 transmits the cooking instruction information to the KD server 3, to instruct the kitchen display 4 to output the cooking instruction information. In addition, in this cooking instruction information, the reservation time (reception time) the number of the person in charge of cooking, the cooking start time are included.

When having received the cooking instruction information from the order station 2, the kitchen printer 5 prints the cooking instruction information on a paper piece, to issue the cooking instruction slip Hb shown in FIG. 6B. The cooking instruction slip Hb is a reservation slip indicating that the reservation order has been received. In the area H1 of the cooking instruction slip Hb, the reception time of the ordered item by the customer is stated. That is, in the case of the reservation order processing, the reservation time (reception time) is stated in the area H1. As shown in FIG. 6B, “reservation time 12:30” is stated in the area H1 of the cooking instruction slip Hb, for example. In addition, in the cooking instruction slip Hb, the area H2 for displaying the time when the slip has been outputted is provided. In the area H2, “Aug. 29, 2018 10:51” is stated, for example. Further, in the cooking instruction slip Hb, the area H3 for stating the slip number, the area H4 for stating the person in charge of cooking, and the area H5 for stating the name of the ordered item and the number of the ordered items are provided. In the area H3, “99999” is stated, for example. In the area H4, “XXX” is stated, for example. In the area H5, “AAA 10” is stated, for example. The cooking instruction slip Hb is printed by the kitchen printer 5, and thereby that the reservation order has been received and the reception time of the ordered item by the customer are transmitted to the person in charge of cooking of the kitchen.

Similarly, the processor 131 of the KD server 3 receives the cooking instruction information from the order station 2, and makes the kitchen display 4 display the cooking instruction information. The kitchen display 4 displays the cooking instruction information, based on the instruction (refer to the step S5) from the KD server 3. In the cooking instruction information, the reception time (reservation time) of the ordered item by the customer is included. By this means, that the reservation order has been received, and the reception time of the ordered item by the customer are transmitted to the person in charge of cooking of the kitchen.

The processings from the acceptance of the reservation input in the handy terminal 9 or the Web site for reservation to the output instruction of the cooking instruction information (the cooking instruction slip Hb) to the KD server (the kitchen display 4) and/or the kitchen printer 5 are performed instantly. By this means, the person in charge of cooking can be aware of presence of the reservation order.

Next, in a step S6 of FIG. 4, the processor 121 of the order station 2 confirms whether or not the current time is the execution start time (cooking start time) of the processing for the reservation order. When the current time is not the execution start time of the processing for the reservation order (step S6: No), the processor 121 of the order station 2 waits until the current time becomes the execution start time of the processing for the reservation order. And when the current time becomes the execution start time of the processing for the reservation order (step S6: Yes), the processing of the processor 121 of the order station 2 proceeds to a step S7. In the step S7, the processor 121 transmits the cooking instruction information to the KD server and/or the kitchen printer 5 again to make the kitchen display 4 and the kitchen printer 5 output the cooking instruction information. The reservation time (reception time) is included in the cooking instruction information. The second cooking instruction information functions as a reminder.

The cooking instruction information as the reminder is transmitted several tens of minutes before the reservation time (reception time). That is, the execution start time of the processing for the reservation order is a time several tens of minutes before the reservation time, and is the cooking start time which has been calculated in consideration of the cooking time of the food and drink (ordered item) which has been ordered by reservation. The processor 121 of the order station 2 transmits the cooking instruction information to the KD server 3 and/or the kitchen printer 5 at the cooking start time. By this means, the ordered item such as the food and drink which has been ordered by reservation is surely cooked without being late for the reception time, and thereby it becomes possible to provide the ordered item to the customer.

When the standard cooking time of the ordered item AAA is 20 minutes, the cooking instruction information is transmitted to the kitchen printer 5 and so on (12:00) 30 minutes before the reception time (12:30) of the ordered item by the customer. That is, the cooking start time is set 30 minutes before the reception time. Here, 30 minutes are obtained by adding a reserve time (10 minutes) to the standard cooking time (20 minutes). By this means, cooking of the ordered item “AAA” will be finished by the reception time by the customer, and thereby the ordered item can surely be provided to the customer.

When having received the cooking instruction information (refer to the step S7) from the order station 2, the kitchen printer 5 prints the cooking instruction information on a paper piece to issue the cooking instruction slip Hc shown in FIG. 6C. The cooking instruction slip Hc is a cooking start slip for notifying cooking start of the food and drink which has been ordered by reservation. In the area H1 of the cooking instruction slip Hc, the reception time of the ordered item by the customer is stated. That is, in the case of the reservation order processing, the reservation time (reception time) is stated in the area H1. In the area H1 of the cooking instruction slip Hc, “reminder 12:30” is stated, for example. In addition, in the cooking instruction slip Hc, the area H2 for stating the time (cooking start time) when the slip is outputted is provided. In the area H2, “Aug. 29, 2018 12:00” is stated, for example. Further, in the cooking instruction slip Hc, the area H3 for stating the slip number, the area H4 for stating the person in charge of cooking, and the area H5 for stating the name of the ordered item and the number of the ordered items are provided. In the area H3, “99999” is stated, for example. In the area H4, “XXX” is stated, for example. In the area H5, “AAA 10” is stated, for example. The cooking instruction slip Hc is issued by the kitchen printer 5, and thereby the cooking start time (execution start time of the processing for the reservation order) of the food and drink which has been ordered by reservation is transmitted to the person (XXX) in charge of cooking of the kitchen.

Similarly, the KD server 3 receives the cooking instruction information (refer to the step S7) from the order station 2, and makes the kitchen display 4 display the cooking instruction information. The kitchen display 4 displays the cooking instruction information again, based on the instruction of the KD server 3. In the cooking instruction information, the execution start time (cooking start time) of the processing for the reservation order, and the reception time (reservation time) of the ordered item by the customer are included. By this means, the cooking start time of the food and drink which has been ordered by reservation (execution start time of the processing for the reservation order) is transmitted to the person in charge of cooking of the kitchen.

In this manner, when the execution start time (cooking start time) of the processing for the reservation order approaches, the cooking instruction information is outputted again by the kitchen display 4 and the kitchen printer 5. By this means, the person in charge of cooking can start cooking at a proper time, without forgetting cooking of the food and drink which has been ordered by reservation.

As described above, in the step S4, the processor 121 of the order station 2 selects the person in charge of cooking, and at the same time, obtain the execution start time (cooking start time) of the processing for the reservation order. The processor 121 of the order station 2 obtains the execution start time (cooking start time) of the processing for the reservation order corresponding to the person in charge of cooking, based on the reservation time, the standard cooking time of the ordered item and the person in charge of cooking characteristic information (skill level information). In the hard disk 123 of the order station 2, the item information and the person in charge of cooking characteristic information are stored. In the item information, standard cooking time information of each item (food and drink) is included (refer to FIG. 3A). In the person in charge of cooking characteristic information, the skill level information of the person in charge of cooking is included (refer to FIG. 3B). The processor 121 of the order station 2 corrects the standard cooking time in accordance with the skill level information of the person in charge of cooking, to obtain a time required for the person in charge of cooking to cook the ordered item.

For example, when the person “YYY” in charge of cooking whose cooking skill level is the level 1 cooks the ordered item “AAA”, a time longer than the standard cooking time is set as the cooking time. In the above-described example, the cooking instruction information is transmitted to the kitchen printer 5 and so on 35 minutes before (11:55) the reception time (12:30) of the ordered item by the customer. That is, the cooking instruction slip Hc is printed 5 minutes earlier than the case of the person “XXX” in charge of cooking whose cooking skill level is the level 2. In the area H1 of the cooking instruction slip Hc, “reminder 12:30” is stated, and in the area H2, “Aug. 29, 2018 11:55” is stated. In the area H3 “99999” is stated, in the area H4 “YYY” is stated, and in the area H5, “AAA 10” is stated.

For example, when the person “ZZZ” in charge of cooking whose cooking skill level is the level 3 cooks the ordered item “AAA”, a time shorter than the standard cooking time is set as the cooking time. In the above-described example, the cooking instruction information is transmitted to the kitchen printer 5 and/or the KD server 3 25 minutes before (12:05) the reception time (12:30) of the ordered item by the customer. That is, the cooking instruction slip Hc is printed 5 minutes later than the case of the person “XXX” in charge of cooking whose cooking skill level is the level 2. In the area H1 of the cooking instruction slip Hc, “reminder 12:30” is stated, and in the area H2, “Aug. 29, 2018 12:05” is stated. In the area H3 “99999” is stated, in the area H4 “ZZZ” is stated, and in the area H5, “AAA 10” is stated.

The person in charge of cooking characteristic information (refer to FIG. 3B) can be set arbitrarily for each the person in charge of cooking. The cooking skill level is not limited to three stages (level 1 to 3), but may be further multi stages. In addition, the person in charge of cooking characteristic information can be set arbitrarily for each the item of food and drink. With respect to an item whose cooking time is likely to be affected by the cooking skill level of the person in charge of cooking, the cooking skill level is set in multi stages, and with respect to an item whose cooking time is unlikely to be affected, the cooking skill level may be set in one to two stages. In this manner, the order station 2 obtains the cooking start time based on the characteristic (person in charge of cooking characteristic information) of each the person in charge of cooking, and thereby the food and drink (ordered item by reservation) can be provided at a proper time.

As described above, according to the reservation order processing system 1 and the reservation order processing method of the embodiment, it is possible to surely transmit the cooking start time of the food and drink which has been ordered by reservation to the person in charge of cooking. In addition, without being affected by the characteristic of each the person in charge of cooking, it is possible to provide the ordered item such as food and drink at a proper time. That is, the handy terminal 9 (or the information terminal 13 such as the smartphone which the customer possesses) accepts an order of the ordered item such as food and drink, and transmits the order information to the order station 2. The order station 2 has the item information (refer to FIG. 3A) of food and drink, and the person in charge of cooking characteristic information (refer to FIG. 3B), and when having received the order information, the order station 2 transmits the cooking instruction information to the kitchen printer 5 or the KD server 3. The kitchen printer 5 receives the cooking instruction information, and issues the cooking instruction slip including the cooking instruction information (refer to FIG. 3C). The KD server 3 makes the kitchen display 4 display the cooking instruction information. That is, the handy terminal 9 transmits the order information in which the reception time of the ordered item by the customer has be designated to the order station 2. And, the order station 2 obtains the cooking start time based on the reception time, the item information and the person in charge of cooking characteristic information which are included in the received order information, and transmits the cooking instruction information to the kitchen printer 5 or the KD server 3 at the obtained cooking start time. By this means, the person in charge of cooking can start the cooking at a proper time, without forgetting the cooking start time of the food and drink which has been ordered by reservation. In addition, the ordered item such as the food and drink can be stably provided to the customer, and thereby the provision delay is decreased.

In addition, the person in charge of cooking characteristic information (skill level information) can be set arbitrarily for each the person in charge of cooking. In addition, the person in charge of cooking characteristic information (cooking skill level) can be set arbitrarily for each the item of food and drink. For example, for the item “AAA”, the cooking skill level is set in five stages, and for the item “BBB”, the cooking skill level is set in two stages. By this means, the ordered item such as food and drink can be provided to the customer more stably, and thereby the provision delay can be eliminated.

In the above-described description, the case in which the kitchen display 4 and the kitchen printer 5 are used together, but the embodiment is not limited to this. The embodiment may be a case in which only any one of the kitchen display 4 and the kitchen printer 5 is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reservation order processing system, comprising:
an ordered item acceptance device which accepts a regular order or a reservation order of an ordered item, and transmits information of an accepted order;
an order station which receives the information of the accepted order from the ordered item acceptance device, and transmits cooking instruction information based on the information of the accepted order; and
an output device which receives the cooking instruction information from the order station, and displays or prints the received cooking instruction information, wherein:
the ordered item acceptance device transmits the information of the accepted order including a reception time of the ordered item and item information of the ordered item when the accepted order is the reservation order; and
the order station:
stores characteristic information of a person in charge pertaining to the item information,
obtains a cooking start time of the ordered item based on the reception time included in the information of the accepted order received from the ordered item acceptance device, the item information included in the information of the accepted order, and the characteristic information of the person in charge pertaining to the item information, and
transmits the cooking instruction information to the output device at the obtained cooking start time.

2. The reservation order processing system according to claim 1, wherein the characteristic information of the person in charge is able to be arbitrarily set for each the person in charge.

3. The reservation order processing system according to claim 1, wherein the characteristic information of the person in charge is able to be arbitrarily set for each the item of the ordered item.

4. The reservation order processing system according to claim 1, wherein the order station has:
a communication interface to perform communication with the ordered item acceptance device and the output device;
a storage device to store the item information and the characteristic information of the person in charge pertaining to the item information; and
a processor which:
acquires the information of the accepted order from the ordered item acceptance device via the communication interface,
obtains the cooking start time of the ordered item based on the reception time included in the acquired information of the accepted order, the item information included in the acquired information of the accepted order, and the characteristic information of the person in charge pertaining to the item information stored in the storage device, and
transmits the cooking instruction information to the output device at the obtained cooking start time.

5. The reservation order processing system according to claim 4, wherein the processor of the order station:
determines whether the reception time is included in the acquired information of the accepted order, and
obtains the cooking start time of the ordered item only when the reception time is included in the acquired information of the accepted order.

6. The reservation order processing system according to claim 5, wherein the processor of the order station transmits the cooking instruction information to the output device without obtaining the cooking start time of the ordered item when the reception time is not included in the acquired information of the accepted order.

7. The reservation order processing system according to claim 5, wherein
the storage device of the order station has a data table of the item information including an item name and a standard cooking time of the item, and a data table of the characteristic information of the person in charge including a name of an item in charge and a skill level of the person in charge for each the person in charge, and
the processor of the order station:
selects a person in charge to take charge of cooking of the ordered item with reference to the table of the characteristic information of the person in charge, and
obtains the cooking start time based on the standard cooking time of the item information table, the skill level of the selected person in charge included in the table of the characteristic information of the person in charge, and the reception time included in the information of the accepted order.

8. The reservation order processing system according to claim 7, wherein the processor of the order station transmits the cooking instruction information for advance notice to the output device, via the communication interface, prior to the obtained cooking start time.

9. The reservation order processing system according to claim 8, wherein the processor of the order station re-transmits the cooking instruction information to the output device, via the communication interface, at the obtained cooking start time.

10. A reservation order processing method, comprising:
accepting a regular order or a reservation order of an ordered item to generate information of an order;
generating cooking instruction information of the ordered item based on the generated information of the order; and
displaying or printing the generated cooking instruction information to output the cooking instruction information, wherein
generating the information of the order includes:
generating the information of the order including a reception time of the ordered item and item information of the ordered item when the order is the reservation order;
generating the cooking instruction information includes:
having characteristic information of a person in charge pertaining to the item information, and
obtaining a cooking start time of the ordered item, based on the reception time included in the generated information of the order, the item information included in the generated information of the order, and stored characteristic information of a person in charge pertaining to the item information in the generated information of the order; and
outputting the cooking instruction information includes:
outputting the cooking instruction information at the obtained cooking start time.
